(19) United States
(12) Patent Application Publication
(10) Pub. No.: US 2005/0188183 A1
(43) Pub. Date: Aug. 25, 2005

(54) Digital signal processor having data address generator with speculative register file

(75) Inventors: James F Galeotos, East Taunton, MA (US); Christopher M. Mayer, Dover, MA (US)

Correspondence Address: William R. McClellan;Wolf, Greenfield & Sacks, P.C., 600 Atlantic Avenue, Boston, MA, 02210, US

(73) Assignee: Analog Devices, Inc., Norwood, MA (US)

(21) Appl. No.: 10/786,838

(22) Filed: Feb. 25, 2004

(51) Int. Cl. G06F 9/00

(52) U.S. Cl. 712/225

(57) ABSTRACT

Methods and apparatus for handling speculative addresses in a pipelined digital processor are provided. A digital signal processor includes an address generator configured to generate speculative data addresses, a pipelined execution unit configured to execute instructions using data at locations specified by the speculative data addresses, a speculative register file configured to hold the speculative data addresses as corresponding instructions advance through the execution unit, an architectural register file configured to hold architectural data addresses, and control logic configured to write speculative data addresses to the speculative register file as the speculative data addresses are generated by the address generator and to supply speculative data addresses or architectural data addresses to the address generator. The speculative register file may be configured with sufficient capacity to hold one or more architectural data addresses.

### FIELD OF THE INVENTION

This invention relates to digital processing systems and, more particularly, to methods and apparatus for handling speculative data addresses in a pipelined digital processor. The methods and apparatus are particularly useful in digital signal processors, but are not limited to such applications.

### BACKGROUND OF THE INVENTION

A digital signal computer, or digital signal processor (DSP), is a special purpose computer that is designed to optimize performance for digital signal processing applications, such as, for example, fast Fourier transforms, digital filters, image processing, signal processing in wireless systems, and speech recognition. Digital signal processors are typically characterized by real-time operation, high interrupt rates and intensive numeric computations. In addition, digital signal processor applications tend to be intensive in memory access operations and to require the input and output of large quantities of data. Digital signal processor architectures are typically optimized for performing such computations efficiently.

Digital signal processors may include components such as a core processor, a memory, a DMA controller, an external bus interface, and one or more peripheral interfaces on a single chip or substrate. The components of the digital signal processor are interconnected by a bus architecture which produces high performance under desired operating conditions. As used herein, the term “bus” refers to a multiple conductor transmission channel which may be used to carry data of any type (e.g. operands or instructions), addresses and/or control signals. Typically, multiple buses are used to permit the simultaneous transfer of large quantities of data between the components of the digital signal processor. The bus architecture may be configured to provide data to the core processor at a rate sufficient to minimize core processor stalling.

The core processor may include a data address unit which generates addresses for data moves to and from memory. By generating addresses, the data address unit permits programs to refer to addresses indirectly, using a data address generator register instead of an absolute address. In a pipelined processor, addresses are generated speculatively very early in the pipeline. These addresses allow other pipeline stages to begin operations. When a given operation has been completely finished, an instruction is completed, or committed, and is no longer speculative. A given operation can also fail to complete, and the speculative result is not utilized.

Since the address unit is located early in the pipeline, it must save each speculative result for two purposes. First, speculative results are used as the source of new speculative addresses. Second, the speculative result is required to become an architectural result when the corresponding instruction is completed.

In the case of a pipelined processor having a large number of pipeline stages, a large register structure is needed to hold all of the speculative results. In the most general case, the register structure may be reading in speculative results and storing completed work to an architectural register structure on every cycle. Significant power can be consumed in performing a read/store of a large result value multiple times to multiple register structures.

Accordingly, there is a need for improved methods and apparatus for handling speculative data addresses in a digital processor.

### SUMMARY OF THE INVENTION

According to a first aspect of the invention, a digital signal processor is provided. The digital signal processor comprises an address generator configured to generate speculative data addresses in response to address operands and one or more address parameters, a pipelined execution unit configured to execute instructions using data at locations specified by the speculative data addresses, a speculative register file configured to hold the speculative data addresses as corresponding instructions advance through the execution unit, an architectural register file configured to hold architectural data addresses, and control logic configured to write speculative data addresses to the speculative register file as the speculative data addresses are generated by the address generator and to supply speculative data addresses or architectural data addresses to the address generator. The speculative register file may be configured with sufficient capacity to hold one or more architectural data addresses.

According to a second aspect of the invention, a method for operating a digital signal processor is provided. The method comprises generating a speculative data address in response to an address operand and one or more address parameters; executing an instruction using data at a location specified by the speculative data address in a pipelined execution unit; holding the speculative data address in a speculative register file as a corresponding instruction advances through the pipeline; holding architectural data addresses in an architectural register file; and writing the speculative data address to the speculative register file as the speculative data address is generated by the address generator.

### BRIEF DESCRIPTION OF THE DRAWINGS

For a better understanding of the present invention, reference is made to the accompanying drawings, which are incorporated herein by reference and in which:

FIG. 1 is a block diagram of an example of a digital signal processor;

FIG. 2 is a block diagram of an example of the core processor shown in FIG. 1;

FIG. 3 is a block diagram of an address unit in accordance with an embodiment of the invention;

FIG. 4 is a block diagram of the speculative register file shown in FIG. 3;

FIG. 5 is a block diagram of one set of control registers shown in FIG. 3;

FIG. 6 illustrates an instruction sequence executed by the address unit in accordance with a first example;

FIGS. 7A-7G illustrate the contents of the speculative register file and the control registers as the sequence of instructions shown in FIG. 6 is executed;

FIG. 8 illustrates a sequence of instructions executed by the address unit in accordance with a second example; and

FIGS. 9A-9F illustrate the contents of the speculative register file and the control registers as the sequence of instructions shown in FIG. 8 is executed.

### DETAILED DESCRIPTION

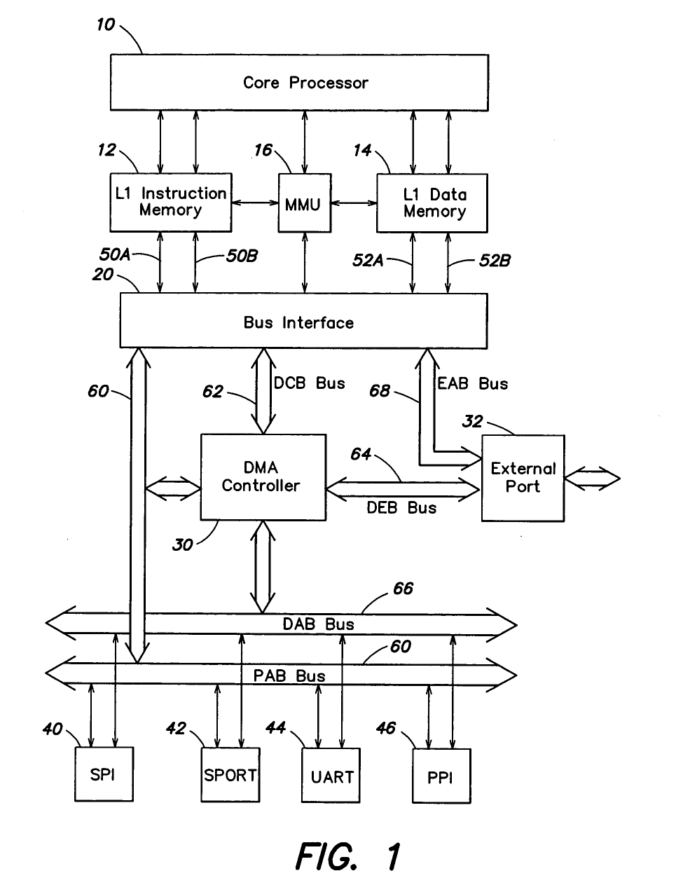

A block diagram of an embodiment of a digital signal processor is shown in FIG. 1. The digital signal processor (DSP) includes a core processor 10, a level one (L1) instruction memory 12, an L1 data memory 14, a memory management unit (MMU) 16 and a bus interface unit 20. In some embodiments, L1 instruction memory 12 may be configured as RAM or as instruction cache and L1 data memory 14 may be configured as RAM or as data cache. The DSP further includes a DMA controller 30, an external port 32 and one or more peripheral ports. In the embodiment of FIG. 1, the DSP includes a serial peripheral interface (SPI) port 40, a serial port (SPORT) 42, a UART port 44 and a parallel peripheral interface (PPI) port 46. The digital signal processor may include additional peripheral ports and other components within the scope of the invention. For example, the digital signal processor may include an on-chip L2 memory.

Bus interface unit 20 is connected to L1 instruction memory 12 by buses 50A and 50B and is connected to L1 data memory 14 by buses 52A and 52B. A peripheral access bus (PAB) 60 interconnects bus interface unit 20, DMA controller 30 and peripheral ports 40, 42, 44 and 46. A DMA core bus (DCB) interconnects bus interface unit 20 and DMA controller 30. A DMA external bus (DEB) 64 interconnects DMA controller 30 and external port 32. A DMA access bus (DAB) 66 interconnects DMA controller 30 and peripheral ports 40, 42, 44 and 46. An external access bus (EAB) 68 interconnects bus interface unit 20 and external port 32.

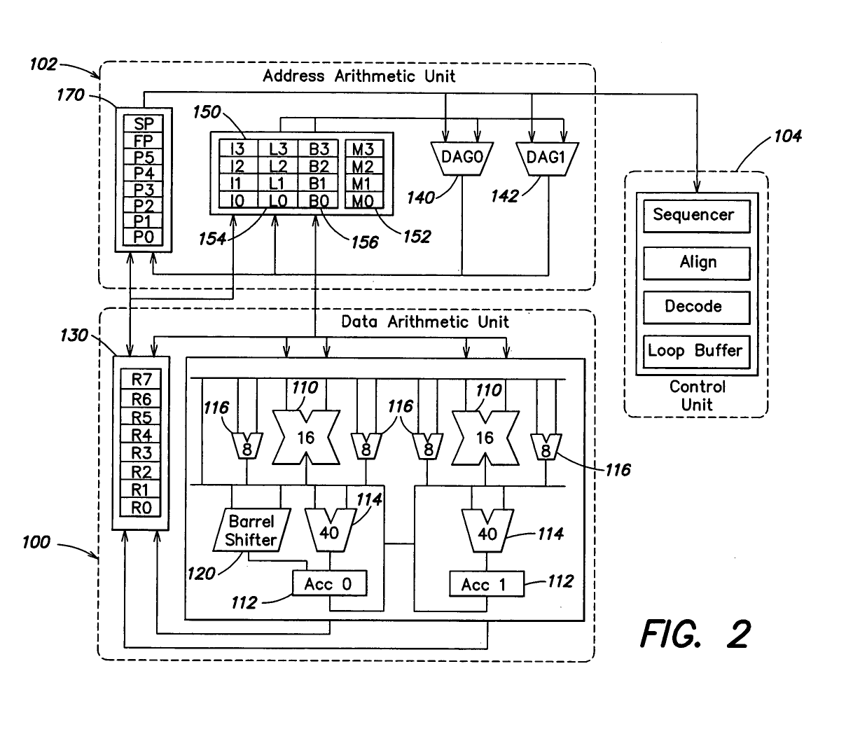

A block diagram of an embodiment of core processor 10 is shown in FIG. 2. Core processor 10 includes a data arithmetic unit 100, an address unit 102 and a control unit 104. The data arithmetic unit 100 may include two 16-bit multipliers 110, two 40-bit accumulators 112, two 40-bit ALUs 114, four video ALUs 116 and a 40-bit shifter 120. The computation units process 8-bit, 16-bit, or 32-bit data from a register file 130 which may contain eight 32-bit registers. Control unit 104 controls the flow of instruction execution, including instruction alignment and decoding.

The address unit 102 includes address generators 140 and 142 for providing two addresses for simultaneous dual fetches from memory. Address unit 102 also includes a multiported register file including four sets of 32-bit index registers 150, modify registers 152, length registers 154 and base registers 156, and eight additional 32-bit pointer registers 170.

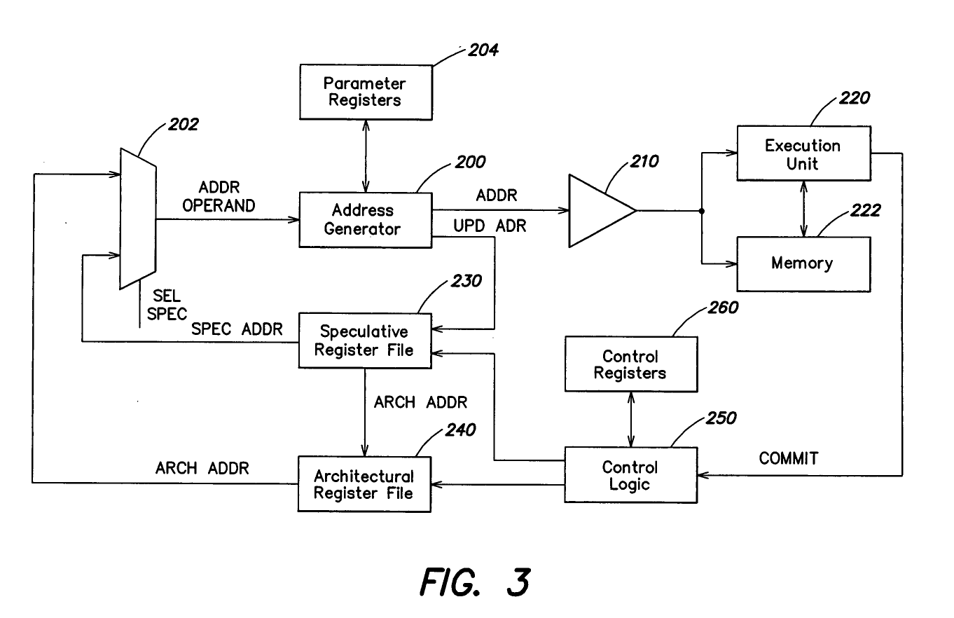

A block diagram of a portion of address unit 102 in accordance with an embodiment of the invention is shown in FIG. 3. An address generator 200 receives an address operand from a multiplexer 202 and one or more address parameters from parameter registers 204. Address generator 200 may correspond to address generator 140 shown in FIG. 2, and parameter registers 204 may correspond to registers 150, 152, 154, 156 and 170 shown in FIG. 2. Address generator 200 performs a specified operation and supplies an address through a buffer 210 to an execution unit 220 and memory 222. By way of example only, address generator 200 may increment the address operand by a modify value from parameter registers 204. The address is used to access data at a specified memory location, and the accessed data is loaded into a specified register for use by the execution unit 220. Address generator 200 also supplies an updated address to a speculative register file 230. Address generator 200 may perform operations such as providing an address during a data access, providing an address during a data move and auto-incrementing/decrementing the stored address for the next move, providing an address from a base with an offset without incrementing the original address pointer, incrementing or decrementing the stored address without performing a data move, and providing a bit-reversed carry address during a data move without reversing the stored address. It will be understood that address generator 200 is programmable and may perform a variety of operations, and that the present invention is not limited in this respect.

Execution unit 220 has a pipelined architecture, including a number of pipeline stages that is selected according to the desired performance. Instructions are fetched from an instruction cache (not shown), decoded and supplied to execution unit 220. The data specified by the address from the address unit is accessed in memory 222 and is supplied to execution unit 220. Execution unit 220 uses the decoded instructions and the accessed data to perform specified operations. When each instruction is completed, a commit signal is generated to indicate completion. The results of execution may be written back to a register file in execution unit 220 or to memory 222.

As noted above, updated addresses generated by address generator 200 are stored in speculative register file 230. Because of the pipelined architecture of execution unit 220, addresses remain speculative until a corresponding instruction has been completed, or committed, by execution unit 220. When the corresponding instruction is committed, the speculative address becomes an architectural address. In some instances, such as in the case of an interrupt, the instruction is not completed and the speculative address does not become architectural.

Speculative register 230 is configured with sufficient capacity to store the speculative addresses associated with each pipeline stage in execution unit 220 and preferably has additional capacity to permit storage of one or more architectural addresses. In one embodiment, execution unit 220 has four pipeline stages, and speculative register file 230 has six locations, or slots. In this embodiment, speculative register file 230 can store four speculative addresses corresponding to the four pipeline stages and up to two architectural addresses. In other embodiments, speculative register file 230 may include more or fewer locations, depending on the number of pipeline stages in execution unit 220 and the desired number of locations for architectural addresses. As discussed below, this configuration provides enhanced performance.

Speculative register file 230 provides a speculative address to multiplexer 202. When available, a speculative address is supplied to address generator 200 as the address operand for calculation of the next address value in accordance with the operation of programmable address generator 200. In the event of a conflict for a location in speculative register file 230, an architectural address is transferred from speculative register file 230 to an architectural register file 240. Architectural register file 240 holds architectural addresses, i.e. addresses corresponding to instructions that have been completed by execution unit 220. Architectural register file 240 supplies an architectural address to multiplexer 202. In the event that a speculative address is not available, multiplexer 202 supplies the architectural address to address generator 200 as the address operand.

The address unit further includes control logic 250 for controlling speculative register file 230 and architectural register file 240. Control registers 260 are associated with parameter registers 204 and are utilized to control speculative register file 230 as described below.

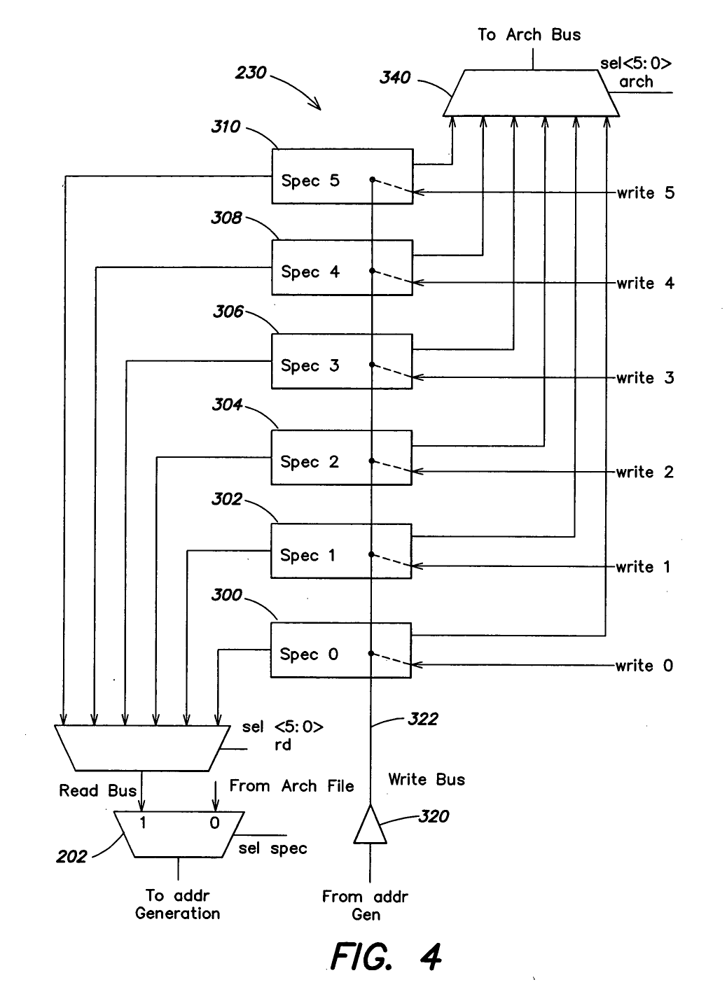

A block diagram of speculative register file 230 in accordance with an embodiment of the invention is shown in FIG. 4. In the embodiment of FIG. 4, speculative register file 230 has six locations 300, 302, 304, 306, 308 and 310, each having capacity for holding a 32-bit data address. It will be understood that different address widths may be utilized. An address from address generator 200 (FIG. 3) is supplied through a buffer 320 to a write bus 322 connected to each of speculative register file locations 300-310. Write lines write 0-5 from control logic 250 (FIG. 3) enable one of the speculative register file locations for writing.

The register file locations 300-310 are connected to a multiplexer 330 which selects one of the locations according to a select read address signal. The output of multiplexer 330 is supplied on a read bus to one input of multiplexer 202. Multiplexer 202 receives a second input from architectural register file 240 (FIG. 2). One of the multiplexer inputs is selected by a select spec signal, and an address operand is supplied to address generator 200, as shown in FIG. 2.

Speculative register file locations 300-310 are also connected to a multiplexer 340 for transfer of an architectural address to architectural register file 240. The desired input of multiplexer 340 is selected by a select architectural signal, and the output is supplied on an architectural bus to architectural register file 240.

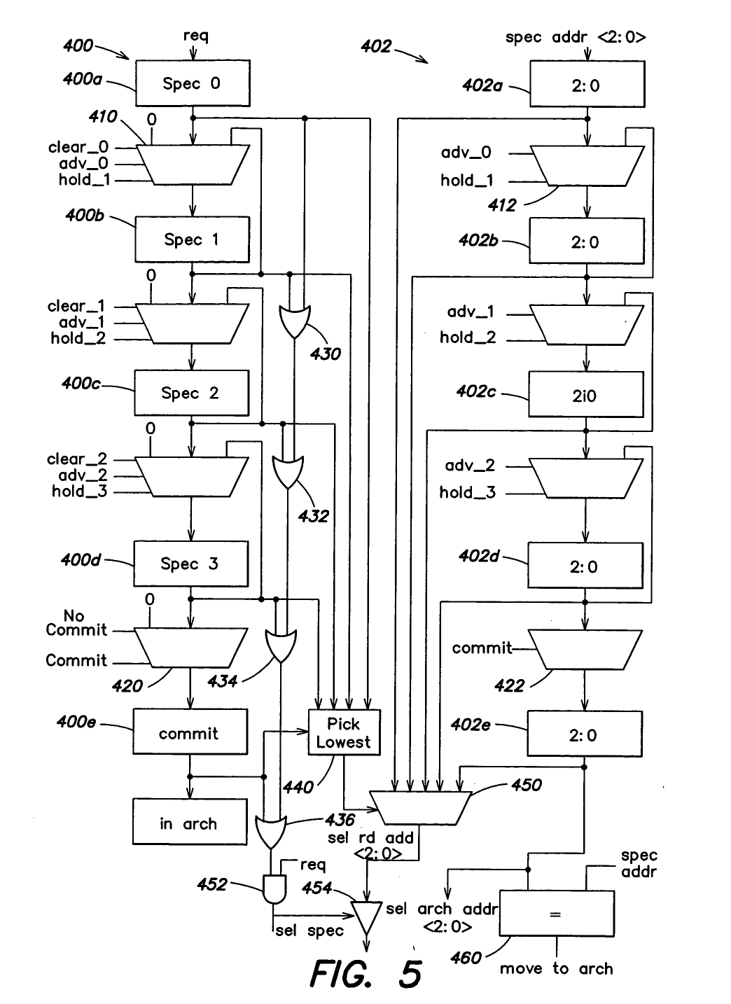

One set of control registers and related control logic for controlling speculative register file 230 is shown in FIG. 5. As noted above, a set of control registers is associated with each of the parameter registers 204 utilized by address generator 200. As shown, the control registers include an in spec register 400 and an address register 402.

The in spec register 400 includes one location corresponding to each pipeline stage in execution unit 220 and a commit location. Thus, for the example of a four-stage execution unit, in spec register 400 includes five locations. In spec register 400 thus includes locations 400a, 400b, 400c, 400d and 400e. Each location of in spec register 400 has a single bit that indicates whether a location in speculative register file 230, as identified by a corresponding address in address register 402, contains a speculative address.

Address register 402 also contains one location corresponding to each pipeline stage and a commit location. Thus, for the example of a four-stage pipeline, address register 402 has five locations, which correspond to the respective locations of in spec register 400. Each location in address register 400 is capable of storing a 3-bit address that identifies a location in speculative register file 230. Address register 402 thus includes locations 402a, 402b, 402c, 402d and 402e. The addresses held in address register 402 are to be distinguished from the data addresses held in speculative register file 230. The addresses held in address register 402 represent locations in speculative register file 230.

The contents of in spec register 400 and address register 402 are advanced through the respective register locations on successive processor cycles as the corresponding instructions advance through pipelined execution unit 220 (FIG. 3). Control muxes between locations determine whether the values in the register locations are advanced to the next stage, are held or are cleared. Thus, for example, control mux 410 between locations 400a and 400b of in spec register 400 receives clear-0, advance-0 and hold-0 control signals which are generated in response to the operations of the first stage of execution unit 220. Control mux 410 receives the output of location 400a at a first input, the output of location 400b at a second input and a zero at a third input. If the advance-0 signal is received, the value in location 400a is transferred to location 400b. If the hold-0 signal is received, the value in location 400a is held in location 400a. If the clear-0 signal is received, a zero is loaded into location 400b. Similar control muxes are located between successive locations of in spec register 400. In the case of location 400e, a control mux 420 receives commit and no commit signals which indicate whether the corresponding instruction has completed in execution unit 220. In the case of a no commit signal, a zero is loaded into location 400e, indicating that the speculative address did not become architectural.

Similarly, control mux 412 is connected between location 402a and location 402b of address register 402. Control mux 412 receives the advance-0 and hold-0 control signals corresponding to the operation of the first pipeline stage. If control mux 412 receives the advance-0 signal, the address value in location 402a is advanced to location 402b. If control mux 412 receives the hold-0 signal, the address value in location 402a is held in that location. In this embodiment, control mux 412 does not receive the clear-0 signal. Similar control muxes are located between successive locations in address register 402. A control mux 422 between locations 402d and 402e of address register 402 receives the commit signal. In the event that the corresponding instruction completed, the address is advanced from location 402d to location 402e. If the instruction was not completed, a dummy address may be loaded into location 402e.

A series of OR gates 430, 432, 434 and 436 receives the outputs of locations 400e-400e of in spec register 400. The output of OR gate 436 indicates whether a speculative value for this address parameter is present in speculative register file 230. Pick lowest logic 440 receives the outputs of locations 400a-400e of in spec register 400 and identifies the earliest pipeline stage having a speculative address for this address parameter. The output of pick lowest logic 440 is supplied to a control input of a multiplexer 450. Multiplexer 450 receives the address outputs of locations 402a-402e of address register 402. The output of multiplexer 450 is the select read address signal supplied to multiplexer 330 (FIG. 4) in speculative register file 230. The output of OR gate 436 is logically anded by a gate 452 with a request signal from address generator 200 and is supplied as a select spec signal to multiplexer 202 (FIGS. 3 and 4). The select spec signal is also supplied to a control input of a buffer 454. The select read address from multiplexer 450 is supplied to the control input of multiplexer 330 only if requested and if a speculative address is present in speculative register file 230.

A comparator 460 receives an address from location 402e in address register 402 and the address of the next write to speculative register file 230. The address value in location 402e indicates the address in speculative register file 230 of an architectural address. If the address values supplied to comparator 460 match, the comparator output signal initiates a move to the architectural register file 240 of the architectural address in that speculative register file location. If the address values do not match, a move to the architectural register file is not required.

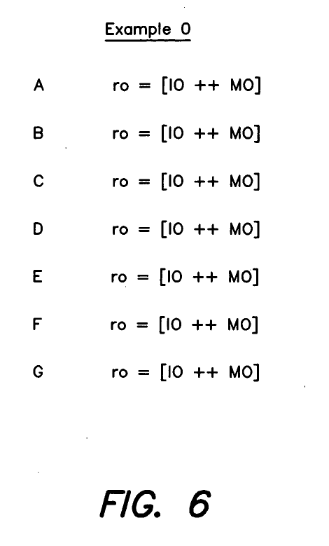

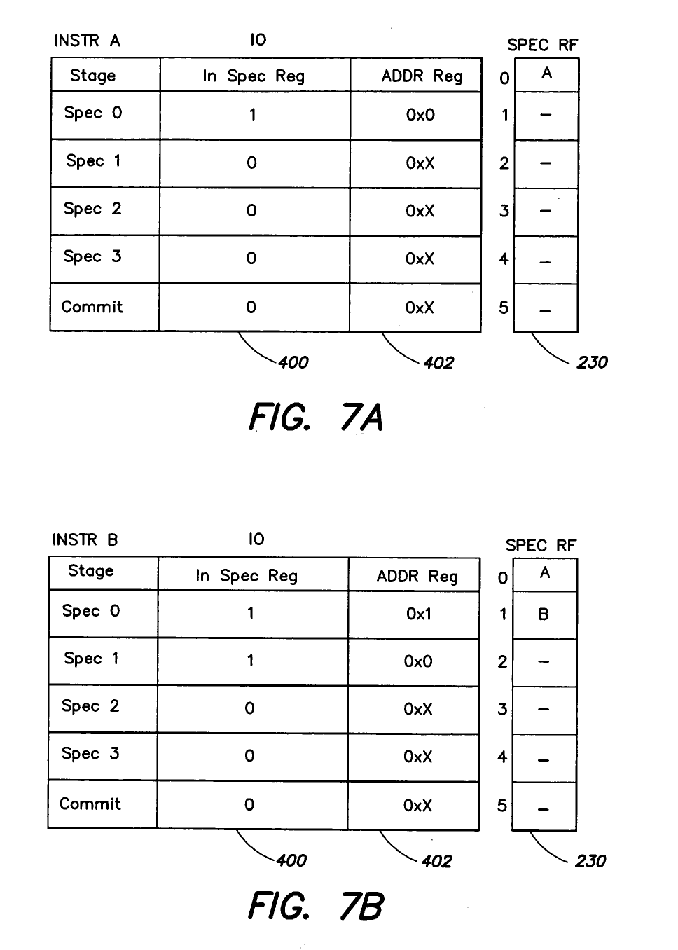

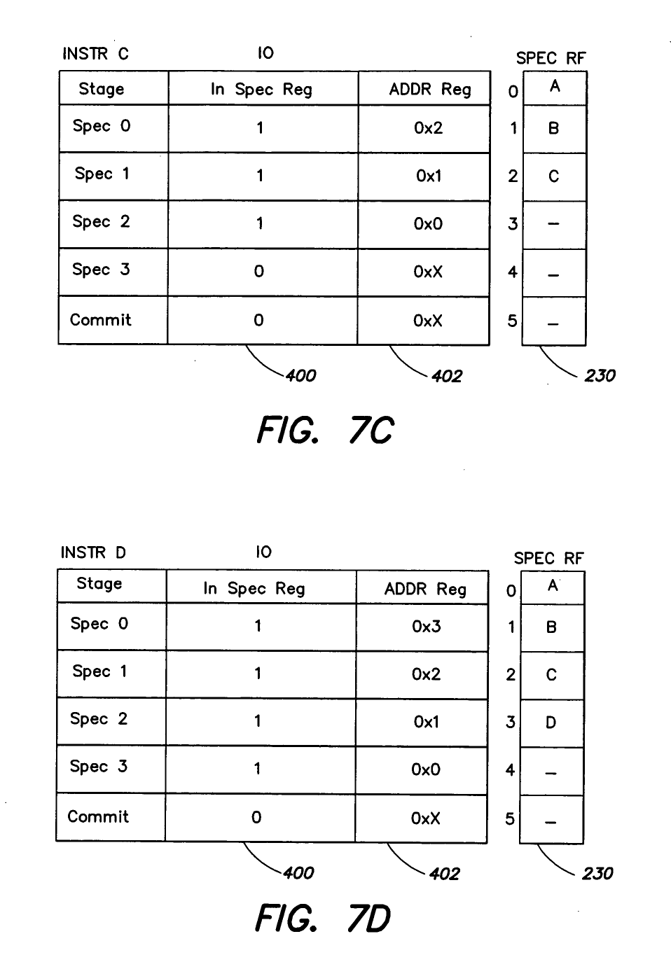

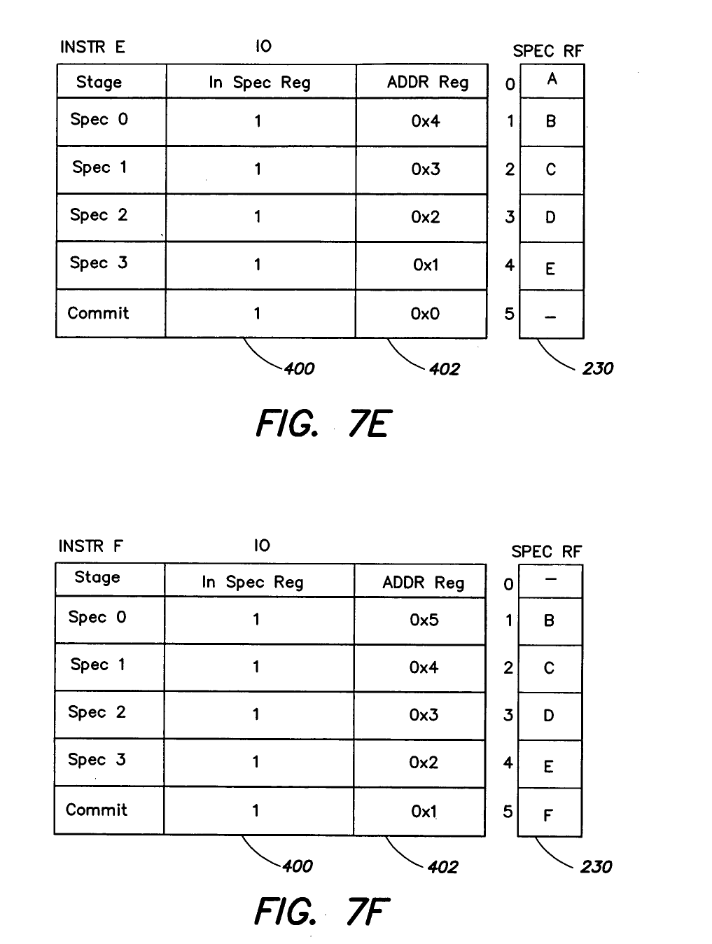

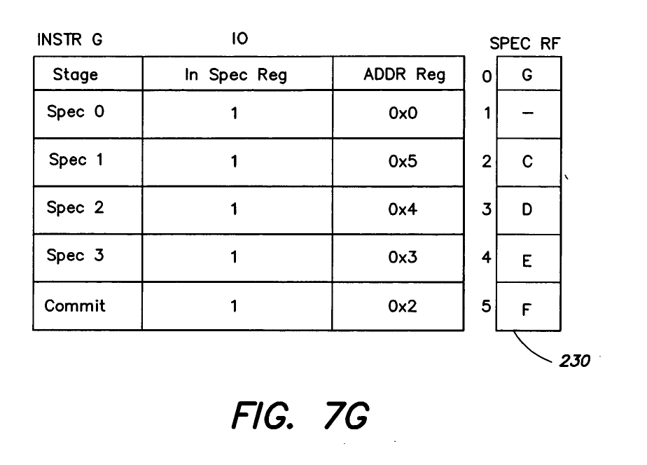

Operation of the address unit may be understood with reference to an example illustrated in FIGS. 6 and 7A-7G. FIG. 6 illustrates an instruction sequence including instructions A-G executed by address generator 200 (FIG. 3). FIGS. 7A-7G illustrate the contents of speculative register file 230, in spec register 400 and address register 402 as the instruction sequence is executed. In the example of FIG. 6, an address generation instruction is repeated. The instruction loads a data word from a location identified by index register 10 into a destination register r0. The value in index register 10 is updated by a value in a modify register M0 to produce an updated address.

Referring to FIGS. 7A-7G, in spec register 400 and address register 402 are associated with index register 10. As shown in FIG. 7A, a speculative address A corresponding to instruction A is loaded into location 0 in speculative register file 230. A location spec 0 in in spec register 400 (location 400a in FIG. 5) is set to 1 to indicate that address A is located in the speculative register file, and address register 402 is loaded with address 0 of location 0 in the speculative register file. Similarly, with reference to FIG. 7B, address B corresponding to instruction B is loaded into location 1 of speculative register file 230. In each of registers 400 and 402, information corresponding to instruction A is advanced to location spec 1, and information corresponding to instruction B is loaded into location spec 0. This process continues with instructions C and D in FIGS. 7C and 7D, respectively. On each cycle, instructions advance through the pipeline and corresponding information regarding speculative addresses in speculative register file 230 advances through in spec register 400 and address register 402.

In FIG. 7E, instruction A has advanced through the final stage of the execution unit and is committed. Accordingly, address A in speculative register file 230 becomes architectural. Referring to FIG. 7F, instruction B is committed and address B in speculative register file 230 becomes architectural. Because index register 10 can have only one architectural value, address A is no longer architectural and location 0 in speculative register file 230 becomes empty. Referring to FIG. 7G, instruction C is committed and address C in speculative register file 230 becomes architectural. Location 1 in speculative register file 230 is no longer architectural and becomes empty. Address G corresponding to instruction G is written to location 0 in speculative register file 230 and the information corresponding to address G is written in location spec 0 of in spec register 400 and address register 402.

It may be noted that the speculative register file 230 operates as a circular buffer. When addressing reaches the end of speculative register file 230, the address wraps back to the start. Furthermore, it may be observed that the instruction sequence shown in FIG. 6 may be executed indefinitely without a need to write architectural addresses to the architectural register file 240, thus saving power.

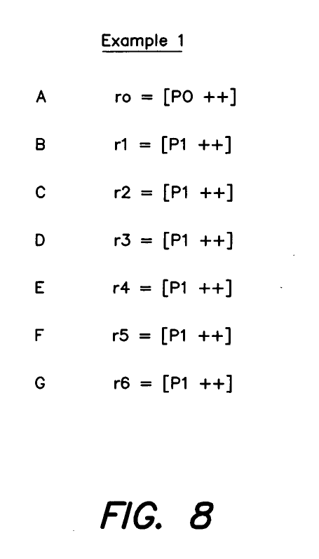

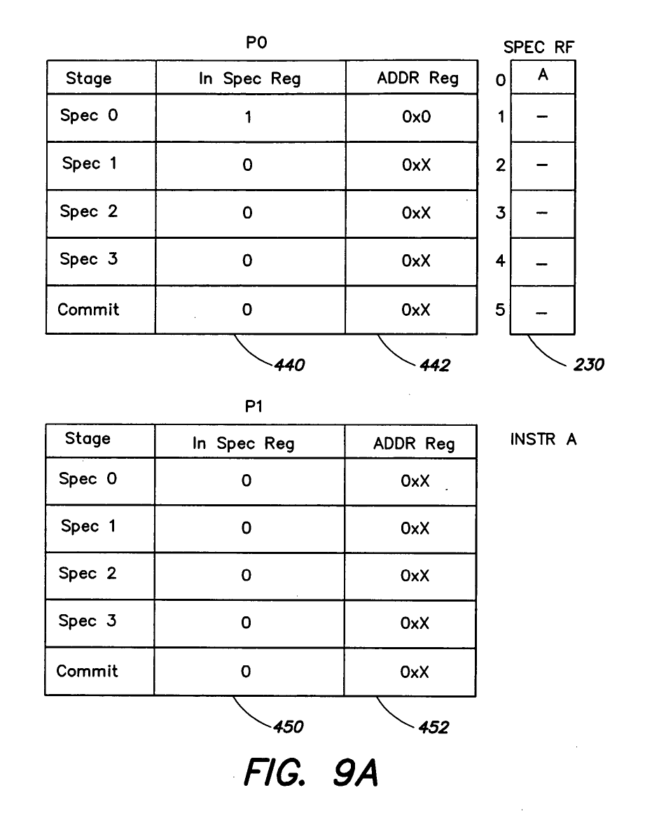

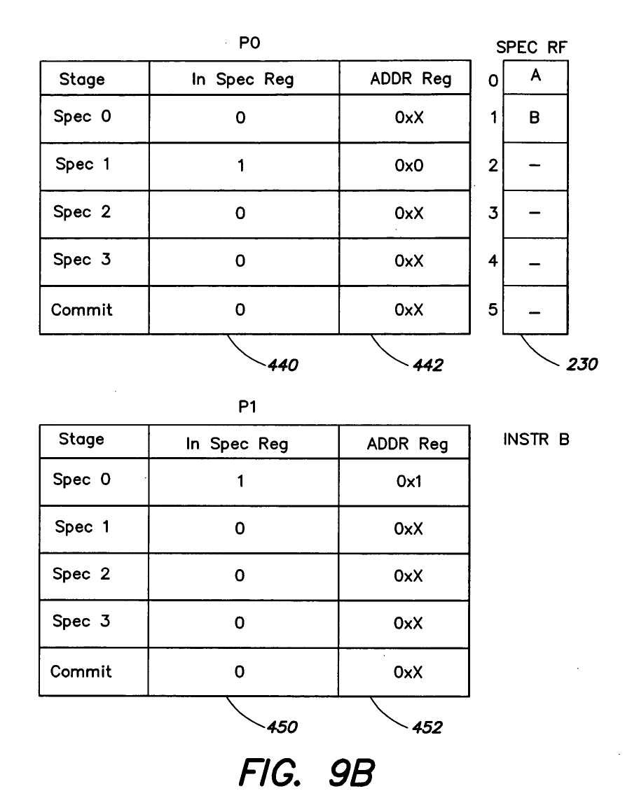

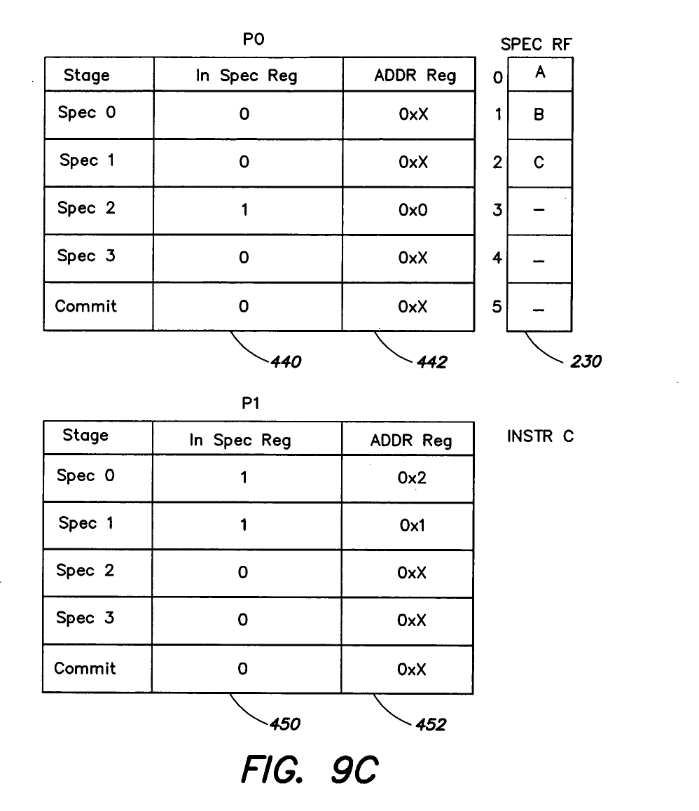

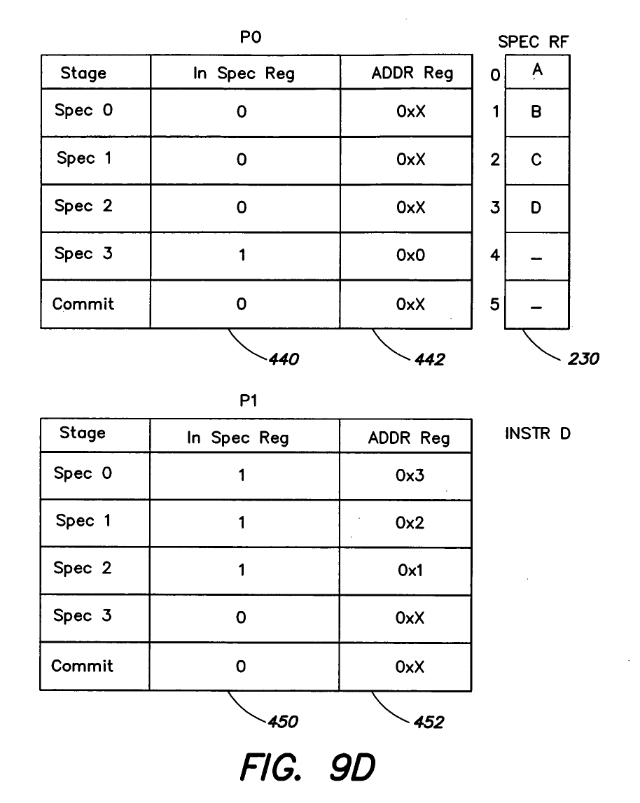

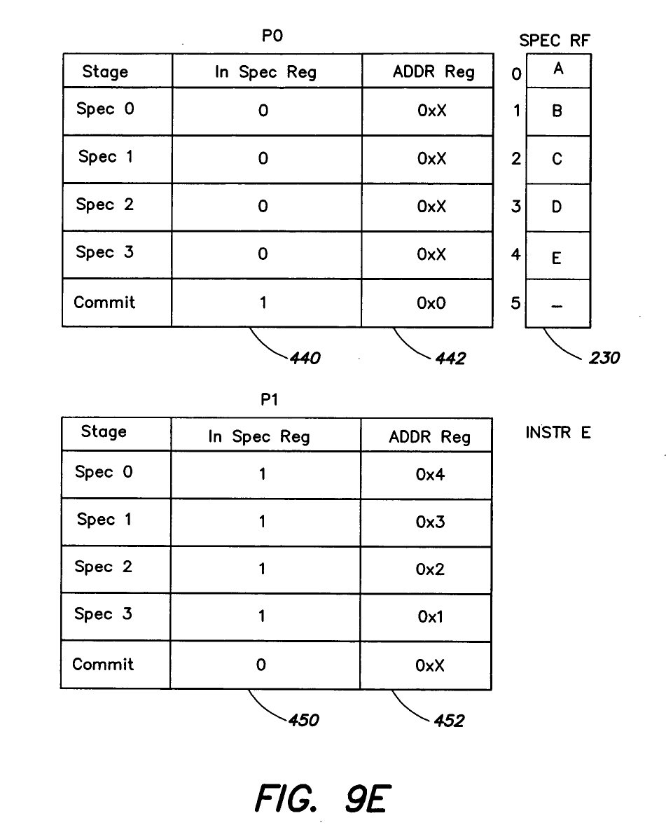

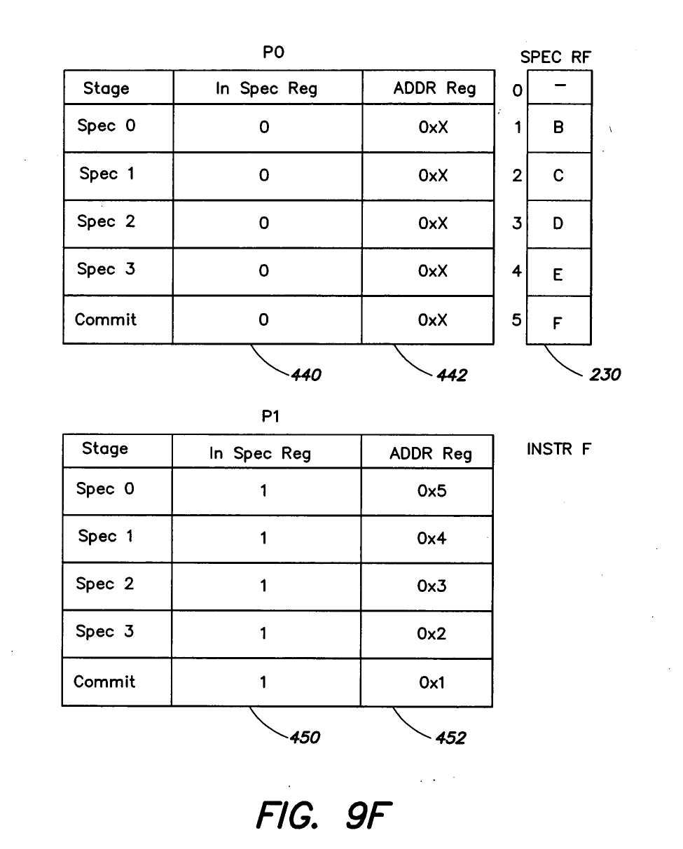

A second example of an instruction sequence is illustrated in FIG. 8. Instruction A loads a data word from a location identified by pointer register P0 and places the data word in register r0. Then pointer register P0 is post-incremented by four. Instructions B-G involve a similar operation with pointer register P1 and different registers r1-r6. FIGS. 9A-9F illustrate the states of speculative register file 230, in spec register 440 and address register 442 associated with pointer register P0 and in spec register 450 and address register 452 associated with pointer register P1, as the instructions advance through the pipelined execution unit.

As shown in FIG. 9A, address A corresponding to instruction A is placed in location 0 of speculative register file 230 and the corresponding information is loaded into location spec 0 of registers 440 and 442, since instruction A involves pointer register P0. No information is loaded into registers 450 and 452 with the execution of instruction A. Referring to FIG. 9B, address B corresponding to instruction B is loaded into location 1 of speculative register file 230. Information corresponding to address B is loaded into location spec 0 of registers 450 and 452, since instruction B involves pointer register P1. The information relating to address A advances to location spec 1 in registers 440 and 442. Similarly for instructions C and D as illustrated in FIGS. 9C and 9D, respectively, addresses C and D are loaded into locations 2 and 3 of speculative register file 230 and the corresponding information is loaded into registers 450 and 452, since these instructions relate to pointer register P1. Information corresponding to address A advances through registers 440 and 442 on each cycle.

Referring to FIG. 9E, instruction A is committed and address A becomes architectural. Referring to FIG. 9F, instruction B is committed and address B becomes architectural. However, because index register P0 has not been modified, address A remains architectural and must be moved to the architectural register file 240 to make room for the next speculative address. Thus, address A is written to architectural register file 240, leaving location 0 of speculative register file 230 available for writing of the next speculative address.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A digital signal processor comprising:
an address generator configured to generate speculative data addresses in response to an address operand and one or more address parameters;
a pipelined execution unit configured to execute instructions using data at locations specified by the speculative data addresses;
a speculative register file configured to hold the speculative data addresses as corresponding instructions advance through the execution unit;
an architectural register file configured to hold architectural data addresses; and
control logic configured to write speculative data addresses to the speculative register file as the speculative data addresses are generated by the address generator and to supply speculative data addresses or architectural data addresses to the address generator.

2. A digital signal processor as defined in claim 1, wherein the speculative register file is configured with sufficient capacity to hold one or more architectural data addresses.

3. A digital signal processor as defined in claim 2, wherein the control logic is configured to move architectural data addresses from the speculative register file to the architectural register file in the event of a conflict for use of the speculative register file.

4. A digital signal processor as defined in claim 3, wherein the control logic is configured to write speculative data addresses to successive slots in the speculative register file.

5. A digital signal processor as defined in claim 4, wherein the control logic is configured to increment a pointer to a next available slot in the speculative register file.

6. A digital signal processor as defined in claim 5, wherein the control logic is configured to wrap the pointer from an end of the speculative register file to a start of the speculative register file.

7. A digital signal processor as defined in claim 3, wherein the control logic is configured to mark as architectural an entry in the speculative register file in response to the corresponding instruction being completed by the pipelined execution unit.

8. A digital signal processor as defined in claim 7, wherein the control logic is configured to mark as empty a slot in the speculative register file containing an old architectural data address when a current architectural data address is defined.

9. A digital signal processor as defined in claim 7, wherein the control logic is configured to mark as empty a slot in the speculative register file when the speculative data address stored therein does not become an architectural data address.

10. A digital signal processor as defined in claim 1, wherein the control logic is configured to update a control register corresponding to the one or more address parameters when a speculative data address is written to the speculative register file.

11. A digital signal processor as defined in claim 1, wherein the speculative register file comprises a circular buffer.

12. A digital signal processor as defined in claim 1, wherein the speculative register file has more slots than a number of pipeline stages in the pipelined execution unit.

13. A digital signal processor as defined in claim 1, wherein the speculative register file has two more slots than a number of stages in the pipelined execution unit.

14. A method for operating a digital signal processor, comprising:
generating a speculative data address in response to an address operand and one or more address parameters;
executing an instruction using data at a location specified by the speculative data address in a pipelined execution unit;
holding the speculative data address in a speculative register file as a corresponding instruction advances through the pipeline;
holding architectural data addresses in an architectural register file; and
writing the speculative data address to the speculative register file as the speculative data address is generated by the address generator.

15. A method as defined in claim 14, further comprising moving an architectural data address from the speculative register file to the architectural register file in the event of a conflict for use of the speculative register file.

16. A method as defined in claim 14, further comprising holding one or more architectural data addresses in the speculative register file.

17. A method as defined in claim 14, further comprising generating a next speculative data address based on a current speculative data address.

18. A method as defined in claim 14, further comprising marking as architectural an entry in the speculative register file when a corresponding instruction is completed by the pipelined execution unit.

19. A method as defined in claim 14, further comprising marking as empty a slot in the speculative register file containing an old architectural data address when a current architectural data address is defined.

20. A method as defined in claim 14, further comprising marking as empty a slot in the speculative register file when a speculative data address contained therein does not become an architectural data address.

21. A method as defined in claim 14, further comprising updating a control register corresponding to the one or more address parameters when the speculative data address is written to the speculative register file.
